(19) United States
(12) Patent Application Publication
(10) Pub. No.: US 2021/0075882 A1
(43) Pub. Date: Mar. 11, 2021

(54) COMMUNICATION SERVICES SYSTEM, AND METHOD FOR PROVIDING DIGITAL SERVICES VIA A COMPUTER NETWORK TO END USERS

(71) Applicant: Internetswitch B.V., Zutphen (NL)

(72) Inventor: Maarten WOLZAK, Eefde (NL)

(21) Appl. No.: 16/606,352

(22) PCT Filed: Apr. 17, 2018
(86) PCT No.: PCT/NL2018/050240

§ 371 Date: Oct. 18, 2019

Related U.S. Application Data
(60) Provisional application No. 62/486,632, filed on Apr. 18, 2017.

(51) Int. Cl. H04L 29/08

(52) U.S. Cl. CPC H04L 67/306; H04L 67/34; H04L 67/36; H04L 67/16; H04L 67/18

(57) ABSTRACT

Communication services system, configured to provide digital services via a computer network to devices of end users, the system including:

at least a service provider, connectable to the computer network for providing a plurality of digital services via the network to end-user devices;

a demand settings provider, configured for providing end-user demand settings concerning delivery of the plurality of digital services to the end-user devices;

at least one switch with several discrete positions that are associated with the plurality of digital services, particular for controlling the demand settings provider.

Also provided is a method for providing digital services via a computer network to end users.

The present invention concerns a communication services system, and method for providing digital services via a computer network to end users. More in particular the invention concerns a system to govern demand and supply of digital services between end users and suppliers

Over the past years the Internet has evolved more and more from a service into a utility, carrying all kinds of digital services. Many of those services, like social media, video streaming and online multi-player games, are without subscription fees. The way those service providers create a viable business case to is to sell our attention to advertisers. And those digital services come with new means to attract and captivate our attention. In the race for our attention digital service providers have created many different, extremely refined technologies to get us hooked to their service. This has grown so much that we are now living in a society in which 86% of adults obsessively check their smart phone for a new “fix”. Of course our children get hooked as well, a large proportion of our young ones are self proclaimed social media addicts receiving on average 1600 messages per day.

The current means to control these digital services are lacking. The only means an average household has to stop the continuous flow of distracting messages to the mobile phones of their children is to completely unplug the wifi router. Which might not even be effective if the mobile phone of their children has a “data plan”, enabling the device to receive messages over cell-phone connection.

Next to the family home situation, 65% of US employers claim that there employees, on average, waste 2 hours of their work time per day on social media and text messages with personal relations.

An employer can only ask her employees to ignore those distractions (or to put their smart-phones in do-not-disturb mode but this will result in them not being reachable by phone).

Our society has gained a massive amount of new and very useful digital services but we have no means to effectively control how those service invade our personal and professional lives. Smartphone operating systems are equipped with options to switch on/off each and every individual app's ability to send us notifications but with an average of 28 apps per smartphone it is a very tedious task to quickly and temporarily turn on and off some of the apps. Next to that, you'd also have to turn off the ability for notification on every other device you have, say your tablet, laptop or smart-TV.

The way and frequency that digital services draw us into their sphere of influence turns out to be a big societal problem. Pandemic sleep deprivation, diminishing productivity, large rise in psychiatrical applications, large rise in smart-phone related traffic accidents.

Parents struggle with turning their children away from their phone. Kids turn to their phones all the time, even during social situation which used to be centred around family life. Thereby missing conversations and family-sharing, much needed for their development into responsible adults. Instead, kids share with friends over social media all the time.

People are fiddling with their smart phone during social and intimate situations like funerals. There still is a shared etiquette about when to and when not to turn to your smart phone, but digital services and their notifications are so well thought out and executed that it's immensely hard not to give in to the temptation.

The present invention aims to at least partly alleviate or solve the above-mentioned problems.

To this aim, there is provided a system that is characterized by the features of claim 1. Also, the invention provides a method according to the features of claim 20.

According to an aspect, there is provided a communication services system, configured to provide digital services via a computer network to devices of end users, the system including:
at least a service provider, connectable to the computer network for providing a plurality of digital services via the network to end-user devices;
a demand settings provider, configured for providing end-user demand settings concerning delivery of the plurality of digital services to the end-user devices;
at least one switch, for example a user controllable switch, with several discrete positions that are associated with the plurality of digital services, in particular for controlling the demand settings provider.

In this way, user demand settings can be easily set by a user, wherein the system can act according to those settings to transmit and/or block certain digital services (of the plurality of digital services) to the end-user device that is associated with the respective end user.

In a preferred embodiment, the switch correlates to several logical sets of rules enabling end-users to privately publish to their contracted/authorised service providers which digital services are allowed to be delivered to them.

Furthermore, it is preferred that the demand settings provider is configured to store, for example in a memory, which type of services are currently requested and accepted by any device permanently or temporarily assigned to an end-user.

According to an embodiment, during operation, the demand settings provider utilizes a collection of rules that control which services are requested and accepted at which locations in what situations for which end-user account, of end users registered with the system.

In addition, a preferred embodiment of the invention provides that the switch is operable by an end-user for publishing one or more current requested and accepted services, in particular demand settings, wherein the demand settings provider is configured to cooperate with the switch for receiving the respective switch setting and to publish the resulting demand settings concerning the respective end-user.

According to a preferred embodiment, the service provider is configured to receive current published requested and accepted services concerning a particular end-user from the demand settings provider, and to deliver exactly and only those service to the respective end-user.

As an example, wherein the service provider and demand settings provider can be configured to exchange information via the network for transmitting information regarding the current discrete position of the switch. This information can include various types of information or data, for example a number or an alphanumerical code, demand settings information (associated with a specific switch position) or the-like.

The switch can have various configurations. For example, the switch can be a manual (i.e. manually operable) switch. In a further embodiment, the manual switch is a wall mounted switch, for example at a location and/or vertical level that can be easily reached by a user for switch setting. The switch can e.g. include one or more knobs or levers to provide the respective discrete switch positions.

Also, for example, the manual switch can be located in a building, for example in a room that is accessible to an end-user.

Besides or alternatively, the switch can be a mobile device, having for example a user interface. The device can be configured to digitally provide several discrete switch position, as an example via the user interface. According to a further embodiment, the user interface of the device can be a touch screen. A further embodiment of the switch device is a cellular device, cell phone or tabloid, configured to carry out a switch app (application) that provides the afore-mentioned switch user interface.

Also, the switch is preferably connected or connectable to the network to transmit the set switch position to the demand settings provider.

For example, the switch network connection can be a wired and/or wireless network connection.

Also, in this application, data transmission (e.g. from the switch to the demand settings provider) can include various types of data transmission protocols, as will be clear to the skilled person, including internet data transmission protocols and/or cellular network transmission protocols. In addition, data can be transmitted, e.g., via SMS text messages or by calling a phone number with a voice response system that is associated with (or forms part of) the demand settings provider.

Preferably, the switch as such can have a relatively simple construction, e.g. including a housing with dedicated switch electronics or communication means for communication with/to a remote demand settings provider (for example in case the switch is a wall mounted manually controllable switch). Also, the switch can include e.g. a signal provider for providing a signal or digital information representing the actual discrete position set by an end-user, and/or providing a signal or digital information once the switch position is manually altered by an end-user. The respective switch signal or information can e.g. be transmitted by the switch, via the network, to the remote demand settings provider. The skilled person will appreciate that said switch communication means and switch signal provider can be implemented in various ways.

Preferably, the user controllable switch is configured to send each newly selected switch position to the demand settings provider (e.g. in the form of a suitable signal or digital information) via a network connection, wherein the demand settings provider is in particular configured to receive the newly selected switch position (e.g. said suitable signal or digital information) and to publish respective demand settings information to one or more service providers registered or associated with the demand settings provider.

In a preferred embodiment, the demand settings provider is configured to receive information concerning a selected switch position from the switch, and to store that position, for example in a memory of the demand settings provider, as a rule for a linked end-user account, wherein the demand settings provider is preferably configured to send a notification to each service provider concerning the switch position or rule. In a further embodiment, the switch position as such or rule is not directly communicated to the service provider, wherein only respective/associated demand settings information is communicated (from the demand settings provider to the service provider).

For example, the demand settings provider can be configured to store information concerning particular authorised service providers that are autorised to make use of switch related information concerning the discrete position of the switch.

According to a further embodiment, the service provider is configured to adapt the digital services that are provided to a particular end-user based on the end-user demand settings that are provided to the service provider by the demand settings provider.

Preferably, the discrete switch positions are associated with a number of rules concerning end-user access to digital services, the rules including at least a first rule and a second rule, wherein the first rule allows end-user access to all available digital services, wherein the second rule blocks at least one of the available digital services.

In addition or alternatively, the end-user device can be configured to detect presence in an area of influence, for example via WIFI-detection, the area of influence in particular being associated with an associated account. In a further embodiment, a geolocation is detected by the device, that can e.g. be determined from a GPS (Global Positioning System) signal.

Furthermore, an aspect of the invention provides a compound system, which can for example be a subsystem or demand settings provider, for example a demand settings provider according to the innovative system, the compound system including a software program combined with a user controllable switch with several discrete positions correlating to several logical sets of rules enabling people to privately publish to their contracted/authorised providers which digital services are allowed to be delivered to them.

A non-limiting example of the system, described above, is shown in more detail in the attached drawings (as will be explained below).

Also, there is provided a subsystem that is defined by the features of claim 17.

In this way, above-mentioned advantages can be achieved.

The subsystem can e.g. be configured to carry out a collection of rules that control, in a logical manner, which services are requested and accepted at which locations in what situations for which account.

Also, the subsystem can be configured to cooperate with one or more means, for example with a switch, of controlling the requested and accepted services for a account.

In an aspect of the invention, a method for providing digital services via a computer network to end users, for example utilizing a system according to the invention, includes at least the following:
providing a plurality of digital services via the network to end-user devices, via at least one service provider that is connected to the computer network;
connecting at least an end-user device to the computer network for receiving the digital services from the network;
providing end-user demand settings concerning delivery of the plurality of digital services to the end-user devices, in particular by a subsystem or demand settings provider;
wherein the end-user demand settings are being associated with a selected position of at least one switch, providing several discrete positions that are associated with the plurality of digital services.

In this way, also, above-mentioned advantages can be achieved.

The demand settings provider of the system according the invention can be provided and configured in various ways as will be appreciated by the skilled person. The demand settings provider can e.g. be part of a computer or computer system, part of a computer network, network server, et cetera. The demand settings provider can e.g. be located near or in a location of an afore-mentioned service provider, but that is not required. Also, the demand settings provider can be provided by suitable computer code or software. More particular, there can be provided a computer-readable medium having thereon computer executable instructions, which when executed by a computer provide end-user demand settings concerning delivery of a plurality of digital services to the end-user devices, thereby in particular providing the demand settings provider.

As follows from the above, an aspect of the present invention can be a compound system, consisting of a software program combined with a switch (e.g. a manual switch) with several discrete positions correlating to several logical sets of rules enabling people to privately publish to their contracted/authorised providers which digital services are allowed to be delivered to them.

Aspects of the invention can also be:

1. A system with which a person or institution can publish which type of services are currently requested & accepted by any device permanently or temporarily assigned to that person or institution as declared in the person's or institutions account as registered with the system.

2. A collection of rules that control, in a logical manner, which services are requested & accepted at which locations in what situations for which account.

3. Several means of controlling the requested & accepted services for a account.

### Asides

The system can be aimed at supportive, not suppressive, use. No system is “unhackable”. The system can be aimed at behavioural design promoting the “use for good” of time and attention.
The system can be constructed with several complicated parts working together, as will be appreciated by the skilled person. The possibilities to implement the system, and to reach wide adaptation and acceptance of the system, can be dependent on the manner of implementation and execution.
The following provides further embodiments concerning various principles and technology that can be used.

Further advantageous embodiments are described in the dependent claims. Aspects of the invention will now be explained in more detail with reference to the drawings wherein similar or corresponding features are denoted by similar or corresponding reference signs.

### BRIEF DESCRIPTION AND SUMMARY OF THE DRAWINGS

FIG. 1 schematically depicts a non-limiting example of a system according to the invention. In particular, FIG. 1 depicts Supply demand services:

Person A publishes the current requested and accepted services. (Demand settings) Provider B consults the current published requested and accepted services and delivers exactly and only those to person A.

FIG. 2 schematically depicts a Switch on wall:

Manual switch with discrete positions attached to room wall.

FIG. 3 schematically depicts Switch signals system: Manual switch is switched from one position to another and sends the newly selected position to the system over a network connection.

FIG. 4 schematically depicts System notifies authorised 3rd parties:

The system receives a selected position from an identified switch, interprets and stores the position as rule for the linked account and sends a notification to all 3rd party providers currently authorized by the account linked to the identified switch.

FIG. 5 schematically depicts Provider adapts supply to demand:

Provider (e.g. Telecom operator) is notified by the system of a change in demand settings. Provider requests and receives current demand settings and adapts the supply of services to Device (e.g. smartphone) to fit within the demand settings.

FIG. 6 schematically depicts Rule adoption:

The system lists only those demand settings which fit in every rule applicable to the related account. Rule A lists all services as demand settings. Rule B prohibits the delivery of social media because that is not listed in the demand settings. Rule C prohibits email and audio by not listing those demand settings resulting in a compound demand settings of only www (world wide web pages). (The resulting compound demand settings are listed if and when an authorised 3rd party requests a read out of the current demand settings.)

FIG. 7 schematically depicts Area of influence through reachable network:

Person A comes close to structure B. Structure B is fitted with one or more identifiable wireless network devices. Thereby person A comes within the reachability area of the wireless network of an associated account. The device of person A discovers a known wireless network and identifies it as belonging to an associated account.

FIG. 8 schematically depicts: Area of influence through geofencing:

Person A is present at a defined location. The GPS equipped device of person A notices it is within a geofence area and identifies the associated account.

### DETAILED DESCRIPTION

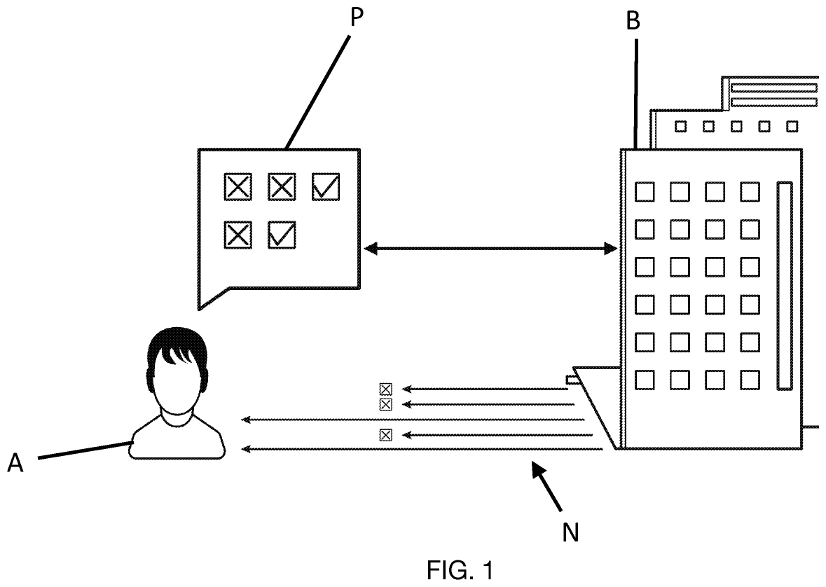

FIG. 1 shows an example of a communication services system, configured to provide digital services via a computer network N to end users A.

The system includes a service provider B, connected to the computer network N for providing a plurality of digital services via the network N to end-user devices D.

Also there is shown an end-user device D of an end user (person) A, connectable to the computer network N for receiving the digital services from the network N.

Further, there is provided an innovative a demand settings provider P, configured for providing end-user demand settings concerning delivery of the plurality of digital services to the end-user devices A.

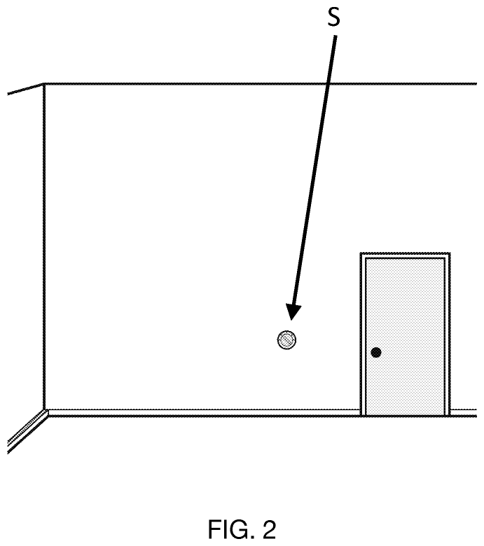

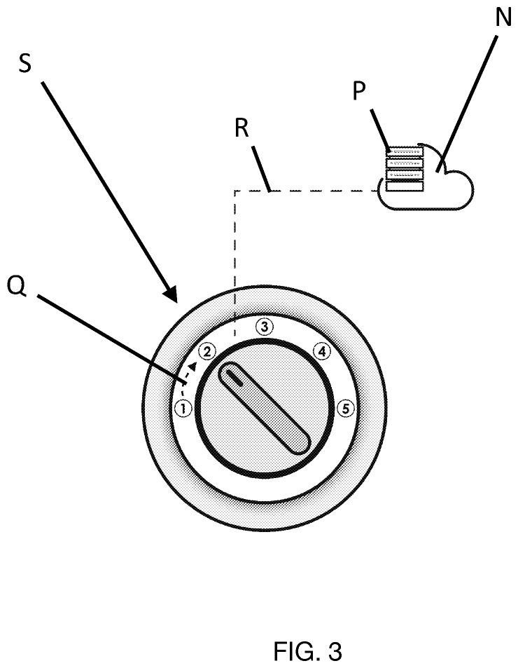

Moreover, importantly, the system includes a manually operably switch S (e.g. having a relatively simple construction), an example of which is shown in FIGS. 2-3. The switch has several discrete, user selectable positions that are associated with the plurality of digital services, in particular for controlling the demand settings provider.

As is shown in FIG. 2, the manual switch S can be a wall mounted switch. The switch S can be e.g. located in a building, for example in a room that is accessible to the end-user A.

The switch can be implemented as a device having a real user actuatable switch element (e.g. knob) that has to be moved between various discrete switch positions. Alternatively, the switch can e.g. be implemented as a switch app in a cellular user device (e.g. mobile phone or tabloid), the app—when executed by the device- providing a user interface (e.g. touch screen) that displays a virtual switch on the touch screen, to be operated by the user (to change a respective switch position) by the user interacting with the touch screen. It follows that the term “manual switch” can be interpreted broadly, since it can include manual control of a movable switch element or user interface control of a software implemented switch (e.g. displayed via the user interface).

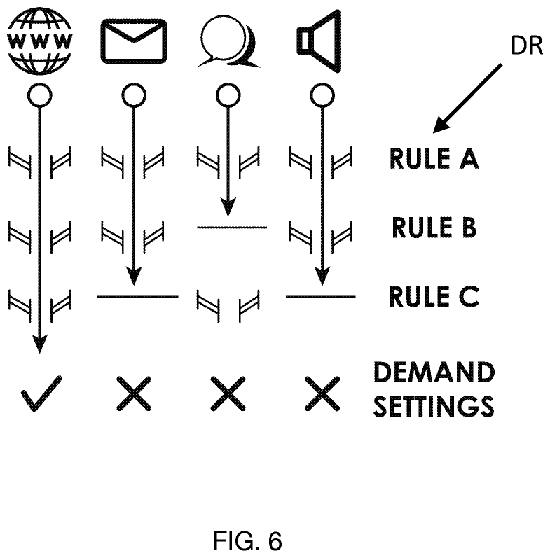

The discrete switch positions (in FIG. 3, five discrete positions are available as an example) can be associated with a number of rules (see FIG. 6) concerning end-user access to digital services, the rules including at least a first rule (rule A in FIG. 6) and a second rule (Rule B in FIG. 6), wherein the first rule allows end-user access to all available digital services, wherein the second rule blocks at least one of the available digital services.

Transmission of information (e.g. information/data streams) over the network N is schematically indicated via respective arrows in the drawing. The network N can be or include or be part of a global digital. computer communication network, in particular Internet, provided by respective network servers and/or network access points and (wired and/or wireless) network connections, as will be appreciated by the skilled person (the respective dedicated network components not being shown in the present drawings). An arrow Q in FIG. 3 indicates adjustment of the switch S from a position 1 to a position 2. A dashed line R in FIG. 3 indicates transmission of the switch setting to the remote demand settings provider P.

The present, manually controllable switch S is preferably configured to send each newly selected switch position to the demand settings provider P via a network connection, wherein the demand settings provider P is in particular configured to receive the newly selected switch position and to publish respective demand settings information to one or more service providers B registered or associated with the demand settings provider P.

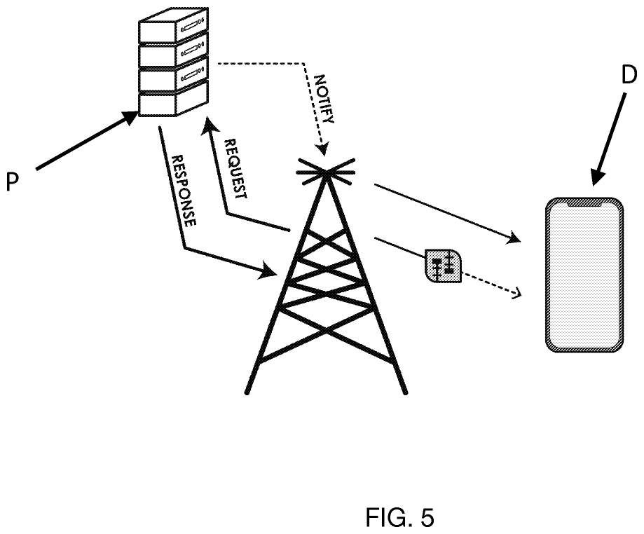

The manual switch S correlates to several logical sets of rules (an example of a set of rules being shown in FIG. 6) enabling end-users to privately publish to their contracted/authorised service providers which digital services are allowed to be delivered to them. The present manual switch S is operable by the end-user A for publishing one or more current requested and accepted services, in particular demand settings. The remote demand settings provider P is configured to cooperate with the switch for receiving the respective switch setting and to publish the resulting demand settings concerning the respective end-user A (as follows from FIGS. 1, 4 and 5). The present service provider B is configured to receive current published requested and accepted services concerning the particular end-user A from the demand settings provider P, and to deliver exactly and only those service to the respective end-user A. Moreover, the service provider B and demand settings provider P are is configured to exchange information via the network N (see the upper double arrow in FIG. 1) for transmitting information regarding the current discrete position of the manual switch S.

The present demand settings provider P is configured to store, for example in a memory (not shown as such), which type of services are currently requested & accepted by any device permanently or temporarily assigned to an end-user.

From the above it follows that the demand settings provider P is preferably configured to receive information concerning a selected switch position from the switch S, and to store that position, for example in a memory of the demand settings provider P, as a rule for a linked end-user account. Further, the demand settings provider P can be configured to send a notification to each service provider B concerning the switch position or rule. Herein, such a notification preferably does not include the specific switch position, wherein the notification can include certain demand settings information that is associated with that switch position. To that aim, the demand settings provider P can e.g. digitally hold or store a list or data set containing the various switch positions and the respective demand settings information.

The present demand settings provider P can also be configured to store information concerning particular authorised service providers B that are autorised to make use of switch related information concerning the discrete position of the switch S.

The present service provider B is configured to adapt the digital services that are provided to the particular end-user A, based on the end-user demand settings that are provided to the service provider by the demand settings provider P.

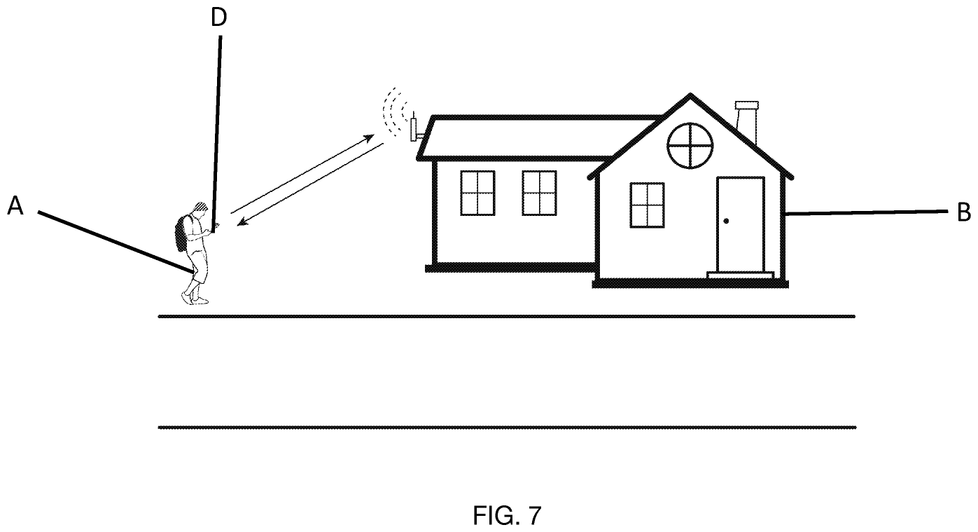

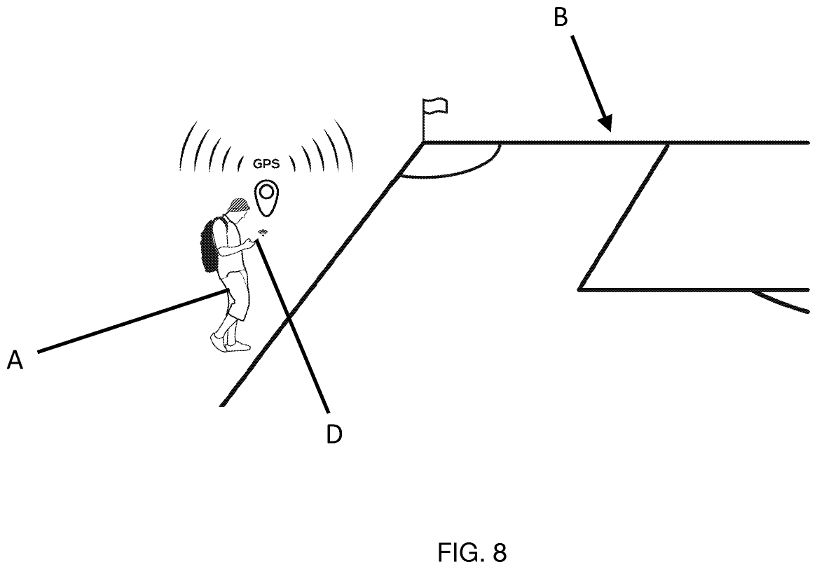

Moreover, as follows from FIGS. 7 and 8, an end-user device D can be configured to detect presence in an area of influence, for example via WIFI-detection and/or Global Positioning System signal detection, the area of influence in particular being associated with an associated account.

During operation of the present system, an end-user A can manually adjust the switch S. The switch S publishes to the service provider B (in particular a contracted service provider B), which digital services are to be currently delivered to each end-user device that is associated with that end-user.

Preferably, during operation, a plurality of end-user devices D can be associated with a predetermined user account (for example a cell phone and a computer or laptop), registered at the service provider B. In that case, preferably, the service provider B only provides the digital services to each of these end-user devices D based on demand settings information concerning (i.e. associated with) a selected discrete position of the manual switch.

A number of devices D can be assigned e.g. to a particular (e.g. centrally registered) end-user A. In that case, the demand settings provider P can store information concerning the type of services that are currently requested and accepted by any of the end-user devices D, in particular based on a selected discrete position of the manual switch S.

During operation, the demand settings provider P utilizes the afore-mentioned collection of rules, and may stores those rules in a respective memory, the rules indicating which services are requested and accepted at which locations in what situations for which end-user account, of registered end users A. Use of the system can also include (preferably centrally) storing end-user registration information concerning end-users registered with the service provider B.

During operation, the manual switch S is manually operated by the end-user A for publishing one or more current requested and accepted services, in particular demand settings. The demand settings provider P receives the respective switch setting from the switch S and publishes the resulting demand settings concerning the respective end-user A. The service provider B receives current published requested and accepted services concerning a particular end-user A from the demand settings provider P, and delivers exactly and only those service to the respective end-user A.

Operation of the switch can involve adjusting the position of the switch S is adjusted from a first to a second position (as in FIG. 3), wherein the switch S (e.g. automatically) sends the newly selected switch position to the demand settings provider P via the respective network connection. The demand settings provider receives the newly selected switch position and publishes respective demand settings information to one or more service providers B registered or associated with the demand settings provider P.

During use, the demand settings provider P receives the information concerning a selected switch position from the switch S, and stores that position, as a rule for a linked end-user account. The demand settings provider can then (automatically) sends a notification to each associated service provider B concerning a change of the switch position, or respective rule (as is mentioned before, such a notification generally can included demand settings information that is associated with the switch position). Then, also, the service provider B adapts transmission of the digital services to a particular end-user A in case of a change in respective end-user demand settings that are provided to the service provider by the demand settings provider P.

In this way, an end-user A can efficiently control transmission of digital services to various (all) user devices D associated with that particular user A.

In the following section, various parts of the system and possible advantageous implementations and respective examples of the system, are further described.

### Accounts

Preferably, accounts or user accounts, e.g. user registration information concerning such accounts, can e.g. be stored in the demand settings provider P.

An account can be used to reach compliance between demand and supply of the deliverance of services, from service providers B to end users

A, at any given moment. An account owner (e.g. end-user) can create, view, edit and delete a account with the system through e.g. the Internet (or network N). Part of the account can be the current demand settings.

The demand settings preferably list the services which should be perceived and trusted, by authorised 3rd parties, to be the services currently wanted and accepted by the account owner. (See FIG. 1: Supply demand services)

The demand: a. is controlled by the account owner or b. copies the demand of another account thereby giving (temporary) control to the owner of the copied account.

Current demand can be accessible and readable by authorised service providers B via e.g. the internet (i.e. network N). When a change in the demand takes place (for instance because the account owner A changes it) a notification is broadcasted to subscribed service providers B. Those service providers B can/should respond by retrieving the new demand settings and changing their supply accordingly.

Service providers B who are able to supply other services then are listed in the demand settings should withhold from delivering any services not listed in the demand settings. If suppliers are carriers of other services, the account owner A authorises them and requests them to actively stop any further delivery, or carrying, of the unrequested services. Only listed services should be delivered to the end user (i.e. to the end-user device or devices D).

Usually, most services will pass through different provider systems B, each provider is responsible for matching the supply to the demand. For instance: a home internet provider is just as responsible for prohibiting de delivery of email service, when email is not listed as requested & accepted service in the demand settings, as the email service provider itself. Further; a device operating system (provider) is also responsible for adhering to the demand setting of the user of the device. And so on and so on for each provider and carrier in the supply chain of the service.

### Types

Several account types can be used in the system, such as the following examples:
Personal accounts are used for natural persons. A personal account can be registered by a person with legal capacity. A personal account can also be registered for another person by a guardian, trustee or curator in case of people without legal capacity or in other applicable situations.
Family accounts are used for an habitual. situation like a family home in a (semi-) fixed location. Personal accounts can be linked to a family account. Personal accounts will be linked to family accounts with different roles. One can be linked as a householder and take control of the demand settings of the family account or one can be linked as a child in which case he/she can not take control of the demand settings of the family account. NOTE: A family account takes precedence over a child account also when a device or account assigned to the child account is used at a location in which a less strict demand setting is current.
Institution accounts are used for institutions with a (semi-) fixed location like (but not limited to) schools, libraries, sport clubs, offices, recreational areas, governmental buildings.

### Linking and Associating

Personal accounts can be linked to family accounts. A link is defined by the role the owner of the personal account has within the family as explained above. This link and it's role is used to correctly apply the family account demand settings to the linked personal account. (See section Rule adoption)

Accounts can be associated with other accounts. A personal account can only be associated to a family account it is not linked to. An association is a voluntary following of another account's demand settings. An association can be made by any account owner to any other account. Personal accounts of people without legal capacity can be associated to other accounts by their guardians. An associated account demand settings are applied when 1. the associating account owner has configured the associating account to do so, 2. a device D assigned to the associating account is within the area of influence of the associated account through reachable network (See FIG. 7: Area of influence through reachable network) or 3. a device assigned to the associating account is within the area of influence of the associated account through geofencing (See FIG. 8: Area of influence through geofencing).

When a device D discovers a network of an associated account or when a device D can tell it is within the geofenced area of an associated institution, software on the device D will send information to the system that it is within the influence of the associated institution so that the system can adapt the current demand settings to those of the associated institution.

### Authorising 3rd Parties

All accounts (i.e. respective information present in the demand settings provider P) are preferably able to authorise systems B of 3rd parties to read the demand settings of that account. Those third parties B can for example be (but are not limited to) Home Internet Service Providers, telecom operators, hardware (-manufacturers), internet service suppliers, social media service suppliers, operating system (-suppliers) and all other entities that deliver or carry digital services to the account owner. Authorised 3rd parties can read the demand settings (from the demand settings provider P), to be able to adapt their supply accordingly. Authorised 3rd parties B can subscribe to be notified, via web-hook or otherwise, of changes in the demand settings of the account.

Example (low level): Account owner A authorises telecom operator B to read account demand settings. During the authorisation process, the telecom operator registers a specific URL where it can be notified of any changes in the demand settings for the account (as indicated by the switch S). After finishing the authorisation process, the system (i.e. demand settings provider P) “pings” the telecom operator at the registered URL. In response to the “ping”, the telecom operator B connects to the system (i.e. demand settings provider P) and requests a read-out of the demand settings for the account. Account owner has current demand for phone, email and www. Telecom operator B enables those services and disables all other services it can deliver like SMS, push notifications, Amber alert, streaming music, video, social media, etcetera.

The next day the account owner A decides she only wants to receive phone calls and changes her account demand settings accordingly (by manually operating the switch S). All authorised and subscribed service providers B receive a notification that there has been a change. In response to the notification, the telecom operator reconnects to the system to read out the current demand settings and disables all services except for the phone service. Other devices and service providers who carry or deliver non-phone services to the account owner also disable or render the non-phone services unusable.

Example (intermediate level):Later that day the account owner changes the demand settings (via the switch S) to only demand music. The system (i.e. demand settings provider P) notifies authorised service providers B of a change. In response, the telecom operator connects to the system (i.e. demand settings provider P) and retrieves the current demand settings and adapts the supply. In the case of music, which is digitally delivered as streaming data, this means that data should be enabled for this account. But because the account owner A only demands music services, all network ports are closed except those related to the delivery of streaming music.

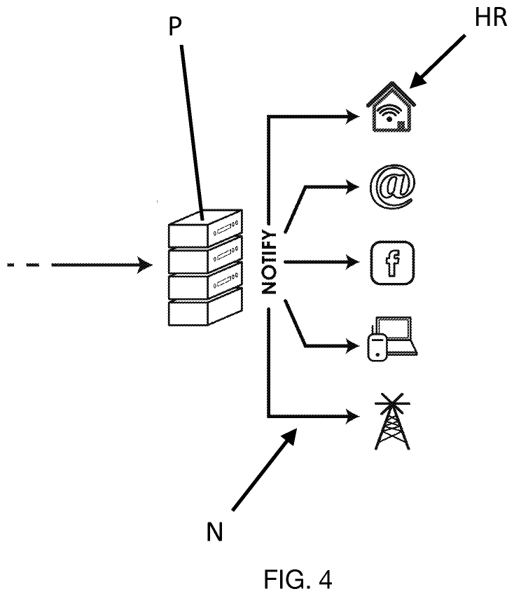

In a further embodiment, a home router HR (for example a local router associated with a home or location of the end user A, configured to locally provide access to the network N to end user devices D -see FIG. 4-) can also connect to the system (i.e. demand settings provider P) and retrieve the current demand settings. The home router HR preferably also changes it's settings in accordance to the current demand settings. It enables data but only over the ports which are part of the definition of the music service. The account owner's smart phone and tablet also regularly connect with the system (i.e. remote demand settings provider P) to check the current demand settings. If the account owner doesn't own a compatible router, the devices preferably adapt to the current demand settings and disable all digital services except music streaming. Any other digital services that arrive at the devices are preferably ignored or suppressed until the demand settings changes again and includes those services.

### Services

Services can be classified according to the technical means necessary to enable and disable them and according to the human understandable type name. Service classifications can also contain a subjective value indicating the intrusiveness of the service. The classification of a service can include any other service classification which is required for the delivery of the service.

For example; the streaming music service of Spotify is classified by the means to enable and disable it. Spotify uses the TCP ports 4371, 4381, 20007, 57621 to deliver the streaming music service. The human readable categorisation would be “music”. The intrusiveness value is 2. The audio and the data service types are required to deliver the music service type.

### Service Definition

The system can provide an online service registration option. An identified or registered service provider can register, define and describe new services. A new service registration is preferably reviewed before it receives a classification and before it can be used by the system and utilised in rules.

### Exempt Services

Some services are preferably exempt from being disabled. For example the communication services used by home appliances in the Internet of things is preferably exempt if the function of the appliances suffer under the disabling of their communication services. Services can be requested to be exempt during the service registration. The review of exempt services can be more strict. On top of the more strict review, an exempt service can still be disabled if it is dependent on technical means which are also used by another service which is not exempt and is preferably disabled according to a accounts dead settings.

For example: some IoT appliances use the XMPP protocol for messaging. The XMPP protocol is also used by a lot of other services like Google chat and others. When chat is not enabled in a account demand settings, XMPP will be disabled by the suppliers, effectively disabling the communication of those IoT appliances.

### Rules

Rules (see FIG. 6) can be defined as sets DR of service types. The use of rules is aimed at enabling the end-user to make decisions about demand settings easier. Instead of the need to control each and every app on each and every device individually, a rule lists the type of services the end user currently requests and accepts and each service provider, including app-makers and suppliers of the underlying OS's, is responsible for adhering to that demand. Shifting the tedious and repetitive task of switching apps abilities on and off from the end user to the service provider. (How the service provider decides to adhere to the demand is up to the service provider.)

For example: a rule for work can exist of a combination of the demand settings: phone, email, www without blacklisted websites. A rule for play time can exist of the combination of demand settings: phone, email, sms, push notification, www without blacklisted websites, music, video, game, social media.

Rules can be a dynamic part of the system. There can be an unlimited possibility of combination of services and therefor an unlimited amount of possible rules. Rules can be used to easily control the demand settings in accordance with the actual requirements of the account owners. A basic set DR of rules is composed to match different general situations in daily life. This is a starting point. General situations in daily life change over time and so do the circumstances and accepted behaviour of those situations. The rules of the system can change along with the social rules of daily life situations. Custom rules can be created and changed by account owners to better fit their individual situations and/or the situations of the family account and/or institution account.

### Rule Adoption

A personal account can be subject to several other accounts. If a account is subject to other accounts, the resulting demand settings preferably only lists those services which are requested & accepted by each demand setting of all related accounts. (See FIG. 6: Rule adoption)

This composition of the resulting demand settings can take the type, of the relation the personal account has to the other account, into account. For instance, a personal account of a child can be subject to the family account and, when at school, the institution account of the school. The system preferably compares the demand settings of the different accounts involved and publishes the strictest combination of those accounts.

For example, during operation, a child account has demand settings of all services except blacklisted websites. The linked family account currently applies the work/study rule allowing only:

phone, email, music and white listed websites.

The child is currently at school whose institution account currently allows:

phone, audio, video and white listed websites.

In this specific case, when an authorised supplier B requests a readout of the demand settings of the personal account, the original personal account settings will be “toned down” by the associated school institution account allowing only phone, audio, video and white listed websites but because the personal account is linked to the family account with a child role, the institution account will be toned down further by the family account; leaving out all audio services except music services. The authorised supplier B will read a current demand setting of:

phone, music and white listed websites.

(See FIG. 6: Rule adoption)

Another example; a woman has her personal account demand settings set to all services except black listed websites. When she is at home her personal account, which is linked to the family account, abides to the family account demand settings. When she is at a friends house, and her device D is connected to the friends wifi router, or the device D notices by another means that it is within the area of influence of the friends family account, her personal account is set to “following” the friends family account. Connecting authorised service providers B will receive demand settings composed of the strictest settings of both her personal account and the friends family account. When a account is influenced by other accounts, any change to the demand settings of the influencing accounts will not only trigger notification of the suppliers of the influencing account but also of the service providers of all influenced accounts.

### Control

A family account or an institution account can be controlled by an aforementioned manually operable (hardware) switch S. This switch S is preferably attached to a wall within the house, the institution or the office. (See FIG. 2: Switch on wall) The present switch has a number of discrete position which are each linked to a rule which in turn is composed of several service types.

By turning the switch to a specific position (See FIG. 3: Switch signals system), the linked rule is activated and the service types which make up the rule are published in the demand settings (via/at/by the demand settings provider P). The authorised service providers B are notified (See FIG. 1: System notifies authorised 3rd parties), they in turn connect to the system (i.e. the demand settings provider P), retrieve the new demand settings for the family account and adapt their supply accordingly (See figure: Provider adapts supply to demand). The system (i.e. demand settings provider P) can also notify the authorised service providers B for all accounts which are influenced by the controlled (family- or institution-) account, triggering them to connect to the system, read the demand settings for the influenced accounts and adapting their supply accordingly.

A personal account can be controlled e.g. online by means of a user interface on a webpage. A personal account can also be controlled by means of SMS; sending an SMS from a phone number connected to a personal account, with a specific rule, to a phone number connected to the system will change the demand settings of the personal account according to the rule indicated by the number in the SMS. A personal account can also be controlled by calling a phone number of the system from a phone number connected to a personal account and responding to a voice response system.

In the foregoing specification, the invention has been described with reference to specific examples of embodiments of the invention. It will, however, be evident that various modifications and changes may be made therein without departing from and scope of the invention as set forth in the appended claims.

In the claims, any reference signs placed between parentheses shall not be construed as limiting the claim. The word ‘comprising’ does not exclude the presence of other features or steps then those listed in a claim.

Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to advantage.

It will be appreciated that the disclosed methods and principles can be implemented in one or more computing devices, i.e., a device having a processor, by the execution of computer-executable instructions read from a computer-readable medium, the instructions being configured to carry out the respective method steps or processes. While such media may be either transitory or non-transitory, in a preferred embodiment the computer-executable instructions are stored on and read from a non-transitory medium such as a hard drive, flash memory, optical memory, programmed array, random access memory, read only memory, alterable read only memory and so on.

1. A communication services system, configured to provide digital services via a computer network to devices of end users, the system including:
at least one service provider, connectable to the computer network for providing a plurality of digital services via the computer network to end-user devices;
a demand settings provider, configured for providing end-user demand settings concerning delivery of the plurality of digital services to the end-user devices; and
at least one switch with several discrete positions that are associated with the plurality of digital services for controlling the demand settings provider.

2. The communication services system according to claim 1, wherein the at least one switch correlates to several logical sets of rules enabling end-users to privately publish to their contracted and/or authorised service providers which digital services are allowed to be delivered to them.

3. The communication services system according to claim 1, wherein the demand settings provider is configured to store in a memory which type of services are requested and accepted by any device permanently or temporarily assigned to an end-user.

4. The communication services system according to claim 1, wherein during operation the demand settings provider utilizes a collection of rules that control which services are requested and accepted at which locations in what situations for which end-user account, of end users registered with the system.

5. The communication services system according to claim 1, wherein the at least one switch is operable by an end-user for publishing one or more current requested and accepted services, including demand settings, wherein the demand settings provider is configured to cooperate with the at least one switch for receiving the respective switch setting and to publish resulting demand settings concerning the end-user.

6. The communication services system according to claim 1, wherein the at least one service provider is configured to receive current published requested and accepted services concerning a particular end-user from the demand settings provider, and to deliver exactly and only those services to the end-user.

7. The communication services system according to claim 6, wherein the at least one service provider and the demand settings provider are is configured to exchange information via the computer network for transmitting information regarding a current discrete position of the at least one switch.

8. The communication services system according to claim 1, wherein the at least one switch is a wall mounted switch.

9. The communication services system according to claim 1, wherein the at least one switch is located in a building in a room that is accessible to an end-user.

10. The communication services system according to claim 1, wherein the at least one switch is configured to send each newly selected switch position to the demand settings provider via a network connection, wherein the demand settings provider is configured to receive the newly selected switch position and to publish respective demand settings information to one or more service providers registered or associated with the demand settings provider.

11. The communication services system according to claim 1, wherein the demand settings provider is configured to receive information concerning a selected switch position from the at least one switch, and to store that position in a memory of the demand settings provider, as a rule for a linked end-user account, wherein the demand settings provider is configured to send a notification to each service provider concerning the at least one switch position or rule.

12. The communication services system according to claim 1, wherein the demand settings provider is configured to store information concerning particular authorized service providers that are authorized to make use of switch related information concerning the discrete positions of the at least one switch.

13. The communication services system according to claim 1, wherein the at least one service provider is configured to adapt the plurality of digital services that are provided to a particular end-user based on the end-user demand settings that are provided to the at least one service provider by the demand settings provider.

14. The communication services system according to claim 1, wherein the discrete positions of the at least one switch are associated with a number of rules concerning end-user access to the plurality of digital services, the rules including at least a first rule and a second rule, wherein the first rule allows end-user access to all available digital services, wherein the second rule blocks at least one of the available digital services.

15. The communication services system according to claim 1, wherein the end-user device is configured to detect presence in an area of influence via WIFI-detection, the area of influence being associated with an associated account.

16. A compound system comprising the demand settings provider of the system according to claim 1 and a software program combined with the at least one switch with several discrete positions correlating to several logical sets of rules enabling people to privately publish to their contracted and/or authorized providers which digital services are allowed to be delivered to them.

17. The system according to claim 16, wherein the demand settings provider is configured to publish which type of services are currently requested and accepted by any device permanently or temporarily assigned to a person or institution as declared in the person's or institutions account as registered with the system.

18. The system according to claim 17, wherein the demand settings provider is configured to carry out a collection of rules that control, in a logical manner, which services are requested and accepted at which locations in what situations for which account.

19. The system according to claim 18, configured to cooperate with one or more switches, of controlling the requested and accepted services for an account.

20. A method for providing digital services via a computer network to end users utilizing the system according to claim 1, the method including:
providing a plurality of digital services via the computer network to the end-user devices, via the at least one service provider that is connected to the computer network;
connecting at least one of the end-user devices to the computer network for receiving the plurality of digital services from the computer network; and
providing end-user demand settings concerning delivery of the plurality of digital services to the end-user devices by a subsystem or demand settings provider;
wherein the end-user demand settings are being associated with a selected position of the at least one switch, having several discrete positions that are associated with the plurality of digital services.

21. The method according to claim 20, wherein the end-users are configured to manually adjust the at least one switch and thereby publish to the service provider which digital services are to be delivered to each end-user device that is associated with each end-user.

22. The method according to claim 20, wherein a plurality of end-user devices is associated with a predetermined user account, registered at the at least one service provider, wherein the at least one service provider only provides the plurality of digital services to each of these end-user devices based on information concerning a selected discrete position of the at least one switch.

23. The method according to claim 20, including assigning a number of end-user devices to an end-user, wherein the demand settings provider stores information concerning types of services that are currently requested and accepted by any of the end-user devices based on a selected discrete position of the at least one switch.

24. The method according to claim 20, wherein the demand settings provider utilizes a collection of rules stored in a memory, the rules indicating which services are requested and accepted at which locations in what situations for which end-user account, of registered end users.

25. The method according to claim 20, including storing end-user registration information concerning the end-users registered with the at least one service provider.

26. The method according to claim 20, wherein the at least one switch is manually operated by an end-user for publishing one or more current requested and accepted services, including demand settings, wherein the demand settings provider receives the respective switch setting from the at least one switch and publishes resulting demand settings concerning the end-user.

27. The method according to claim 20, wherein the at least one service provider receives published requested and accepted services concerning a particular end-user from the demand settings provider, and delivers exactly and only those services to the end-user.

28. The method according to claim 20, wherein a position of the at least one switch is adjusted from a first position to a second position, wherein the at least one switch sends a newly selected switch position to the demand settings provider via a network connection, wherein the demand settings provider receives the newly selected switch position and publishes respective demand settings information to one or more service providers registered or associated with the demand settings provider.

29. The method according to claim 20, wherein the demand settings provider receives information concerning a selected switch position from the at least one switch, and stores that position in a memory of the demand settings provider, as a rule for a linked end-user account, wherein the demand settings provider sends a notification to each service provider concerning a change of the at least one switch position, or rule.

30. The method according to claim 20, wherein the at least one service provider adapts transmission of the digital services to a particular end-user in case of a change in respective end-user demand settings that are provided to the at least one service provider by the demand settings provider.

31. The method according to claim 20, wherein the discrete positions of the at least one switch are associated with a number of rules concerning end-user access to digital services, the rules including at least a first rule and a second rule, wherein the first rule allows end-user access to all available digital services, wherein the second rule blocks at least one of the available digital services.

32. (canceled)

33. A non-transitory computer-readable medium having thereon computer executable instructions, which when executed by a computer provide end-user demand settings concerning delivery of a plurality of digital services to the end-user devices, via the demand settings provider of the system according to claim 1.
